(19) United States
(12) Patent Application Publication
(10) Pub. No.: US 2008/0183940 A1
(43) Pub. Date: Jul. 31, 2008

(54) Computer Switch Having Integrated Direct Connection And Scan Interface Structures

(76) Inventor: Tony Lou, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/627,375

(22) Filed: Jan. 26, 2007

(51) Int. Cl. G06F 13/40

(52) U.S. Cl. 710/316

(57) ABSTRACT

A computer switch having integrated direct connection and scan interface structures is mainly developed for improving upon the features under the framework of a CAT5 KVM switch, and in particular adopting under the structure of a switch of scan switch UART type. The switch can still be electrically-connected to control terminals and computing device terminals, respectively. In addition, the switch can include the switch portion of traditional scan-switch-typed switch with UART structure (namely having several control terminal UARTs and computing device terminal UARTs, a multi-channel switch array device, a controller), but also includes additional multi-channel switch device and background scan UART. The multi-channel switch device and background scan UART transmit the system status of the computing device terminals and the signals of the requested control terminal to the controller via the multi-channel switch device. Thus those uncontrolled computing device terminals can still be monitored in real-time.

### BACKGROUND OF THE INVENTION

1. Field of the Invention

The present invention is generally related to a computer switch, and in particular to a computer switch for integrating direct connection and scan interface structures.

2. The Prior Arts

With the increase of machine densities, quantities, and types, it has become more and more difficult to perform system management due to the messy complexities of the communication lines. Therefore, enterprises are urgently needing to have an operation management system that is able to be centrally controlled, having reduced management difficulties of the server room, with improved work efficiency, and has eliminated various man-made safety dangers. As a result, KVM related products have appeared on the market one after another.

KVM is the abbreviation for Keyboard, Video and Mouse. The KVM switch system is a management equipment for cluster systems. By appropriately allocating the keyboard, mouse, and video output devices, and performing a multitude of switch connections on various different host machines, all of the surplus keyboards, mice, and video displays can be eliminated, thus providing floorspace savings for housing computers and servers, and power consumption is thereby reduced. As a result, the mode for operation management of the computer room can be simplified, the work efficiency can be enhanced, and the safety and system reliability can be improved.

In the traditional KVM switch device, the cable lines between the control terminal (or the operator terminal) and the computing device terminals (such as PCs) are mainly used for transmitting audio-visual signals (which are able to be shown on the screen) and control signals (which are activated by the keyboard, mouse and the like) as well. As a result, when switching to a specific computing device terminal using the switch button on the KVM, the user can see the images as represented by the video signals of the specific computing device terminal on the screen. And at the same time, the remote control operation of the specific computing device terminal is performed directly using keyboard and the mouse.

To extend the distance between the control terminal and the computing device terminal, the cable lines could be CAT5 cable lines, and the corresponding switching mechanism should be used in the KVM switch device for performing the switching procedures. In a CAT5 KVM, a Universal Asynchronous Receiver/Transmitter (UART) is connected to the control terminal and the computing terminal respectively for performing the communication operation of the keyboard, the mouse, and the control signals. The structure of the UART could be fallen into two types: the direct connection type and the scan switch type.

In the direct connection type of UART structure, the KVM switch is directly connected to all PC terminals (computing terminals) and control terminals respectively based on a corresponding quantity. For example, if 32 PCs and 4 control terminals are present, the KVM needs 36 UARTs to connect with them.

The greatest advantage of KVM switch having direct connection UART structure is that the transmission of signals and state is completely performed in real-time. For example, when a PC module is activated, its state is able to be immediately sent to the KVM switch. However, the hardware structure of this type of KVM switch requires more UARTs with the increase of the quantity of PCs and control terminals that are connected. At the same time, the KVM switch has to handle concurrently all of the control and data of all UARTs, which leads to the reliance on using the more expensive CPUs for dealing with the increase in the quantity of connecting terminals. As a result, the KVM switch having direct connection structure is gradually replaced by the KVM switch having scan switch.

FIG. 1 is a schematic view showing a traditional KVM switch of the scan switch type. Referring to FIG. 1, the traditional KVM switch 10 of the scan switch type is electrically-connected to a plurality of control terminals 18a˜18c, a plurality of computing device terminal 20a˜20e, respectively; and the KVM switch 10 comprises a controller 11, a plurality of computing device terminal UARTs 12a˜12c, a plurality of control terminal UARTs 14a˜14c, and a multi-channel switch array device 16. The control terminals 18a˜18c each includes a keyboard, a mouse, and/or a video display.

The control terminal UARTs 14a˜14c of the KVM switch 10 of the scan switch type are electrically connected to the control terminals 18a˜18c, respectively, based on the quantity of the control terminals 18a˜18c. The computing device terminal UARTs 12a˜12c are indirectly electrically-connected to the computing terminals 20a˜20e respectively based on the quantity of the computing terminals 20a˜20e. The multi-channel switch array device 16, arranged between the UARTs 12a˜12c and the computing terminals 20a˜20e, is electrically connected to the computing device terminal UARTs 20a˜20e based on the quantity of the computing terminals 20a˜20e respectively, and is also electrically-connected to the computing device terminal UARTs 12a˜12c. The controller 11 is electrically-connected to the control terminal UARTs 14a˜14c and the computing device terminal UARTs 12a˜12c, respectively, of the same amount.

When the control terminal 18a needs to control the computing device terminal 20b, the control signal sent out by the control terminal 18a will be sent to the selected control terminal UART 14a first, and then to be transferred to the controller 11. When the controller 11 receives the control signal (such as instructions from the keyboard or mouse) of the designated control terminal 18a, it will transfer the signal through the selected computing device terminal UART 12a and the multi-channel switch array device 16 to the selected computing device terminal 20b. When the computing device terminal 20b finishes the control signal process of the instructions from the keyboard and the mouse, the video display or status signal in response to the control signal will again be transmitted to the designated control terminal 18a.

The signal of the PC port of the KVM switch 10 of the scan switch type version is passed through the cheaper multi-channel switch array device 16, and is transferred to one of the computing device terminals 12a˜12c via the multi-channel switch array device 16, without using the computing device terminal UART corresponding to the quantity of the computing device terminals 20a˜20e. Thus, the lower performing and cheaper controller 11 can be selected for use in the KVM switch.

However, under this configuration, due to the uneven amounts of the computing device terminal UARTs 12a˜12c and the computing device terminals 20a˜20e when the computing device terminal UARTs 12a˜12c are all occupied, the unselected computing device terminals would not be able to report the current system status and to request the control terminal to notify its system information (such as the operating status, type, and name of the computing device, and the EDID (Extended Display Identification Data) of the control terminal) to the control terminal via the computing device terminal UARTs 12a˜12c. Therefore, in case of a serious problem occurring at the computing device terminal that requires a person to handle, the user who controls the switch cannot obtain the information of the system status of the computing device terminal unless he has timely switched to the specific device, which thereby result in much inconvenience to the client terminal.

### SUMMARY OF THE INVENTION

The primary objective of the present invention is to provide a computer switch integrating direct connection and scan interface structures. By making use of additional multi-channel switch devices and background scan UARTs, the present invention is able to transmit system status of the computing device terminals and the signals of the requesting control terminal in real-time. Hence, those computing device terminals which aren't controlled by the control terminal can still provide responses and monitoring in real-time.

Based on the above goal, the computer switch having integrated direct connection and scan interface structures according to the present invention mainly improves its features under the framework of a CAT5 KVM switch, and in particular under the structure of a switch of the scan switch UART type. The switch of the present invention can still be electrically-connected to a plurality of control terminals and computing device terminals, respectively; and the switch comprises the switch portion of a traditional scan-switch-typed switch with UART structure (namely a plurality of control terminal UARTs and computing device terminal UARTs, multi-channel switch array device, controller), but also comprises additional multi-channel switch device and background scan UART. The background scan UART of the present invention transmit the system status of the computing device terminals and the signals of the request control terminal to the controller via the multi-channel switch device in real-time.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic block diagram showing a traditional KVM switch in the form of scan switch; and

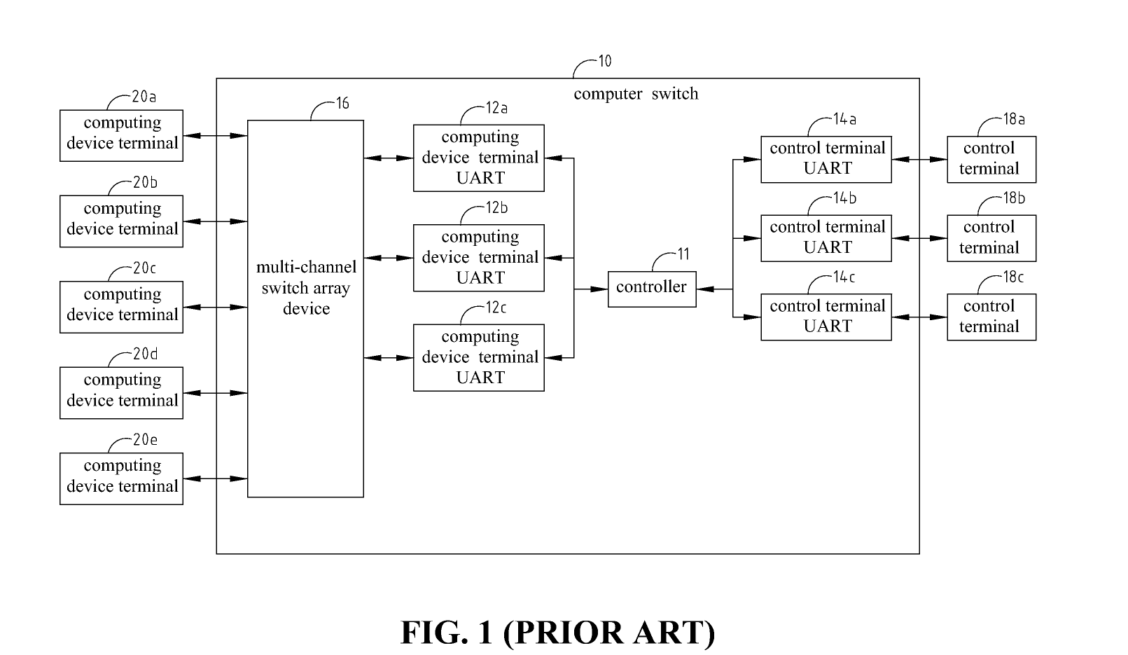

FIG. 2 is a schematic block diagram showing a computer switch having integrated direct connection and scan interface structures constructed in accordance with the present invention.

### DETAILED DESCRIPTION OF THE PREFERRED EMBODIMENT

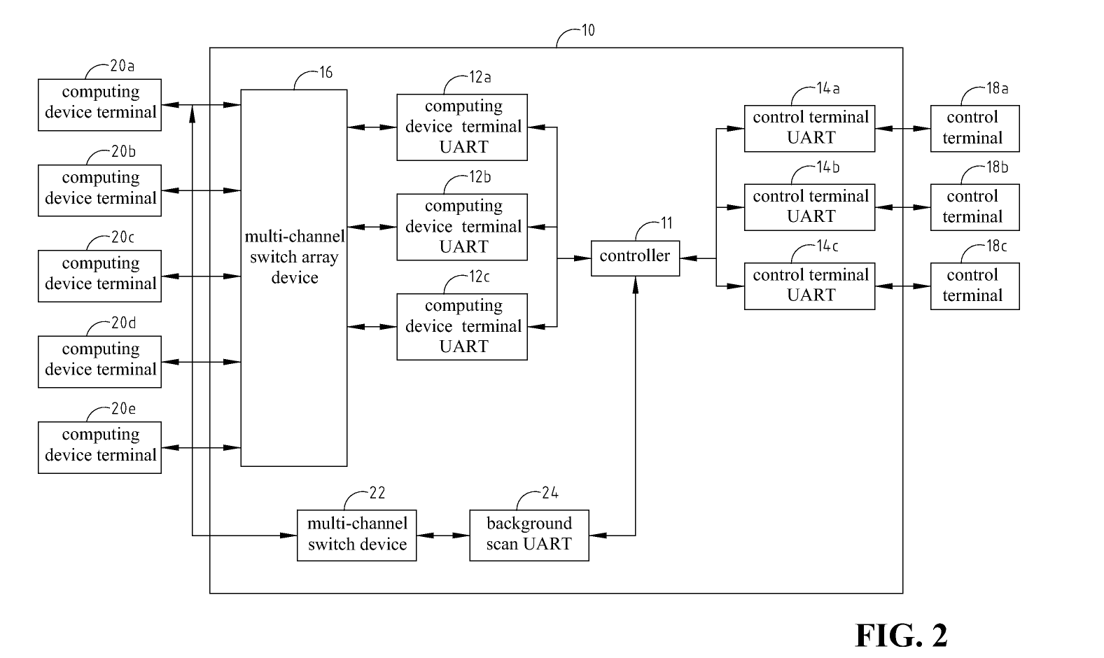

Referring to FIG. 2, FIG. 2 is a schematic block diagram showing a computer switch having integrated direct connection and scan interface structures constructed in accordance with the present invention. Referring to FIG. 2, a computer switch having integrated direct connection and scan interface structures 5 can still be electrically-connected to the control terminals 18a˜18c and the computing device terminals 20a˜20c, respectively. Apart from the traditional switch portion in the form of a traditional scan switch (namely including a controller 11, a plurality of computing terminal UARTs 12a˜12c, a plurality of control device terminal UARTs 14a˜14c, a multi-channel switch array device 16), the present invention further comprises a multi-channel switch device 22 and a background scan UART 24.

The computer switch having integrated direct connection and scan interface structures 5 of the present invention is electrically-connected to the computing device terminals 20a˜20e based on the quantity of the computing device terminals 20a˜20e.

For example, when the uncontrolled computing device terminal 20d is restarted, it can forward this information via the multi-channel switch device 22 and a background scan UART 24, and requires to obtain the system information (such as the EDID information) of one of the control terminals 18a˜18c. Here, the controller 11 can feedback the corresponding information of the control terminal to the computing device terminal 20d in real-time. Hence, the computing device terminals 20a˜20e unselected by the control terminals 18a˜18c for monitoring could be monitored and responded to in real-time. The aforementioned information can be the presence status, type, and name of the computing device terminals, and the EDID data of the controller.

The scan method of the background scan UART 24 is to scan the computing devices 20a˜20e continuously and repeatedly via the multi-channel switch device 22. Upon the detection of the status information or request signal, these massages will be immediately reported back to the controller 11.

In addition, the computer switch having integrated direct connection and scan interface structures 5 constructed in accordance with the present invention includes a number of operating methods which are the same as that of a traditional switch 10. The control terminal UARTs 14a˜14c are electrically-connected to the control terminals 18a˜18c, respectively, based on the quantity of the control terminals 18a˜18c. The computing device terminal UARTs 12a˜12c are indirectly electrically-connected to the computing terminals 20a˜20e, respectively, based on the quantity of the control terminals 14a˜14c. The multi-channel switch array device 16 arranged between the UARTs 12a˜12c and the computing terminals 20a˜20e is electrically connected to the computing device terminal UARTs 20a˜20e based on the quantity of the computing terminals 20a˜20e respectively, and is electrically-connected to the computing device terminal UARTs 12a˜12c. The controller 11 is electrically-connected to the control terminal UARTs 14a˜14c and the computing device terminal UARTs 12a˜12c respectively, which are of the same quantity of terminals.

When the control terminal 18a is required to control the computing device terminal 20b, the control signal sent out by the control terminal 18a will be sent to the selected control terminal UART 14a first, and then to be transferred to the controller 11. When the controller 11 receives the signal (such as instructions from the keyboard or mouse) of a designated control terminal 18a, it can transfer the signal through the selected computing device terminal UART 12a and the multi-channel switch array device 16 to the selected computing device terminal 20b. After the computing device terminal 20b completes the control signals for the instructions of the keyboard and the mouse, the displayed images or status signals responding to the control signals will be again transferred to the designated control terminal 18a.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A computer switch having integrated direct connection and scan interface structures, and electrically-connected to a plurality of control terminals, comprising a keyboard, a mouse, and a video screen; and the computer switch, comprising:
a plurality of control terminal UARTs, electrically-connected to the control terminals based on the quantity of the control terminals, respectively;
a plurality of computing device terminal UARTs, electrically-connected to the computing device terminals based on the quantity of the control terminals, respectively;
a multi-channel switch array device, electrically connected to the computing device terminals based on the quantity of the computing device terminals, respectively, and electrically connected to the computing device terminal UARTs;
a controller, electrically-connected to the control terminal UARTs and the computing device terminal UARTs, respectively, and receiving and transmitting a control signal and a system status of the designated control terminal through the selected computing device terminal UART, and transmitting and receiving the system status and a request signal of the selected computing device terminal via the selected computing device terminal UART and the multi-channel switch array device;
a multi-channel switch device, electrically-connected to the computing device terminals based on the quantity of the control terminals, respectively; and
a background scan UART, handling the request signal of the computing device terminal in real-time via the multi-channel switch device, and transferring the replied information of the control terminal in response to the request signal to the computing device terminal.

2. The computer switch having integrated direct connection and scan interface structures as claimed in claim 1, wherein the system information includes presence status, type, and name of the computing device terminal, the EDID data of the control terminal, or the information that is able to be acquired through the computing device terminals.

3. The computer switch having integrated direct connection and scan interface structures as claimed in claim 1, wherein the background scan UART is to scan the computing devices continuously and repeatedly via the multi-channel switch device, and transmitting the request signal sent out by the computing devices.
